(19) United States
(12) Patent Application Publication
(10) Pub. No.: US 2012/0209698 A1
(43) Pub. Date: Aug. 16, 2012

(54) HYBRID SEARCH RESULTS LISTINGS

(75) Inventors: Vijay Venkatakrishnan, Mountain View, CA (US); Sharad Verma, San Jose, CA (US); Saran Chatterjee, San Jose, CA (US)

(73) Assignee: Yahoo! Inc., Sunnyvale, CA (US)

(21) Appl. No.: 13/026,083

(22) Filed: Feb. 11, 2011

(51) Int. Cl. G06Q 30/00

(52) U.S. Cl. 705/14.49

(57) ABSTRACT

Methods and systems are provided for providing one or more hybrid listings within the algorithmic search results section of a search results page that contains an algorithmic search results section as well as one or more sponsored search results sections. The hybrid listing may be an advertisement, associated with payment or possible payment from an advertiser, that is determined to meet one or more requirements for inclusion in the algorithmic results section. The one or more requirements include a minimum relevancy requirement for inclusion in the algorithmic search results section.

### BACKGROUND

Search results, such as in a search results page, provided in response to an online user search query, may include algorithmic search results, also known as natural or organic search results, as well sponsored search results, where results may include a number of listings. A listing may include a creative, which may include text or other content, as well as a Web page link. Typically, online advertisers pay, through various arrangements, for listings to be included in sponsored search results, whereas inclusion in algorithmic listings does not trigger a payment obligation. Typically, inclusion in algorithmic search results is closely or exclusively linked to relevance. Inclusion in sponsored search results may be based on various factors, which may include the amount of an advertiser bid relating to user search terms, anticipated click through rate, etc.

There is a need for new techniques associated search-related listings

### SUMMARY

Some embodiments of the invention provide methods and systems for providing one or more hybrid listings within the algorithmic search results section of a search results page that contains an algorithmic search results section as well as one or more sponsored search results sections. The hybrid listing may be an advertisement, associated with payment or possible payment from an advertiser, that is determined to meet one or more requirements for inclusion in the algorithmic results section. The one or more requirements include a minimum relevancy requirement for inclusion in the algorithmic search results section.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating method according to one embodiment of the invention;

FIG. 4 is a flow diagram illustrating a method according to one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

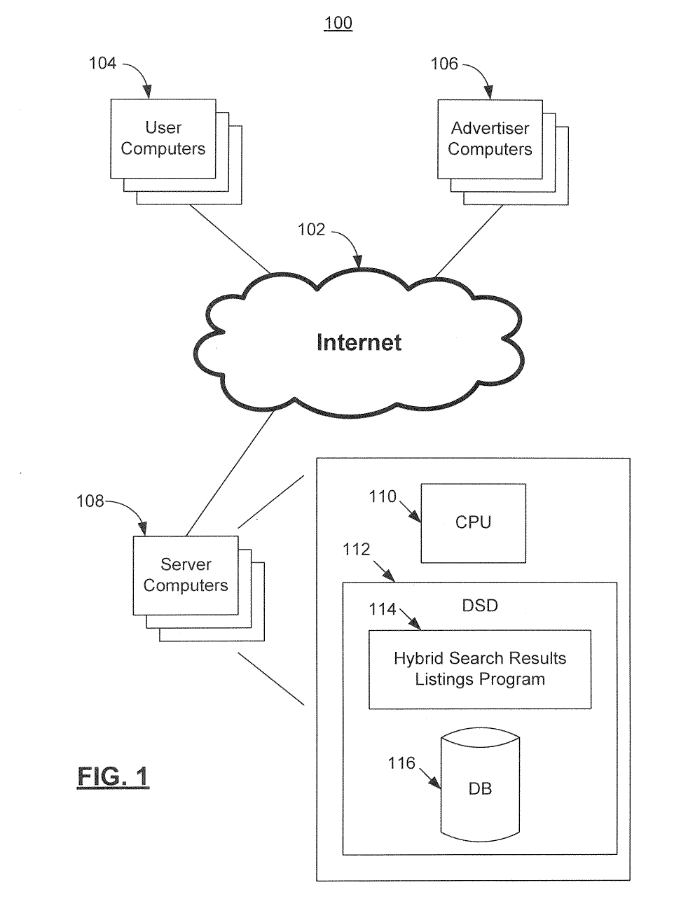

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Hybrid Search Results Listings Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Various monetization techniques or models may be used in connection with sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking. Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay bases on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

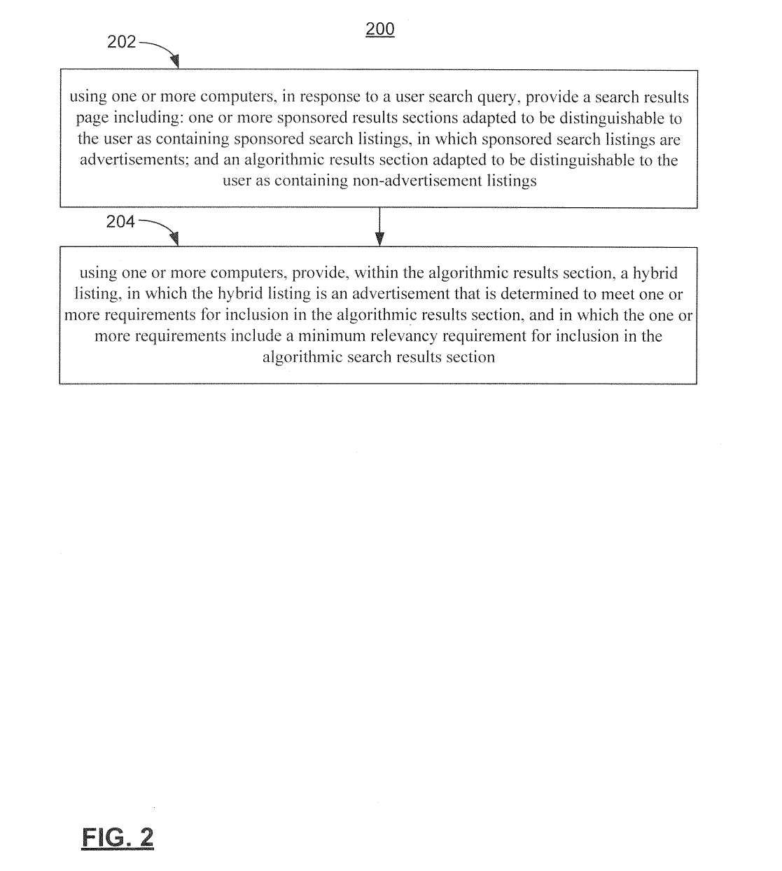

FIG. 2 is a flow diagram illustrating a method 200 according to one embodiment of the invention. At step 202, using one or more computers, in response to a user search query, a search results page is provided. The search results page includes one or more sponsored results sections adapted to be distinguishable to the user as containing sponsored search listings, in which sponsored search listings are advertisements. The search results page further includes an algorithmic results section adapted to be distinguishable to the user as containing non-advertisement listings.

At step 204, using one or more computers, within the algorithmic results section, a hybrid listing is provided, in which the hybrid listing is an advertisement that is determined to meet one or more requirements for inclusion in the algorithmic results section, and in which the one or more requirements include a minimum relevancy requirement for inclusion in the algorithmic search results section.

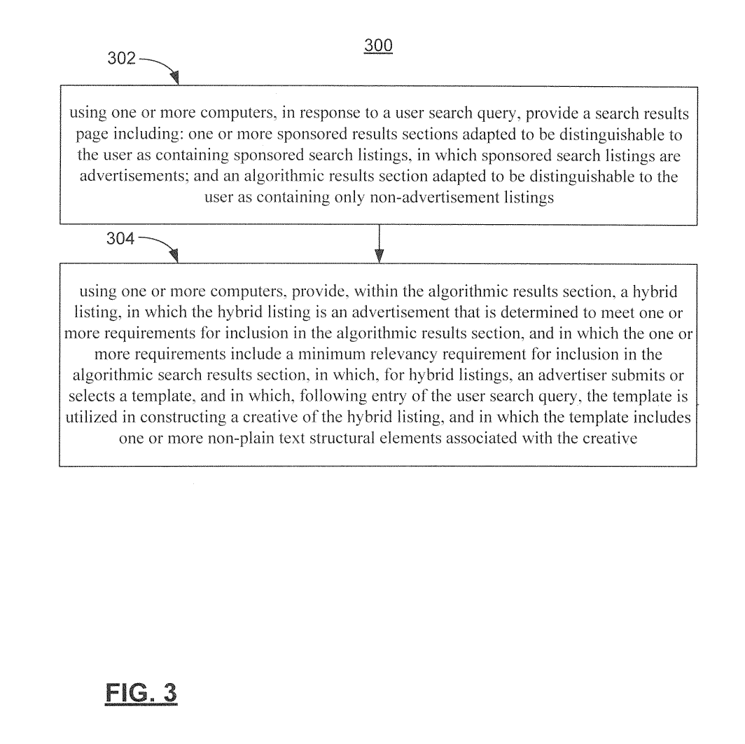

FIG. 3 is a flow diagram illustrating a method 300 according to one embodiment of the invention. Step 302 is similar to step 202 as depicted in FIG. 2.

At step 304, using one or more computers, within the algorithmic results section, a hybrid listing is provided, in which the hybrid listing is an advertisement that is determined to meet one or more requirements for inclusion in the algorithmic results section, and in which the one or more requirements include a minimum relevancy requirement for inclusion in the algorithmic search results section. For hybrid listings, an advertiser submits or selects a template. Following entry of the user search query, the template is utilized in constructing a creative of the hybrid listing. The template includes one or more non-plain text structural elements associated with the creative.

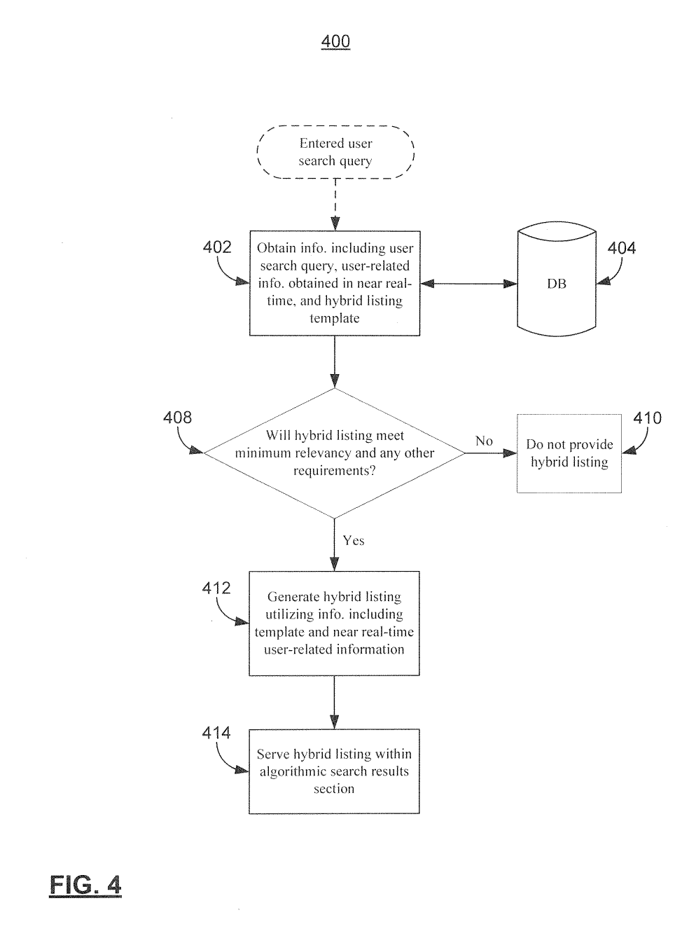

FIG. 4 is a flow diagram illustrating a method 400 according to one embodiment of the invention. At step 402, after obtaining an entered user search query, information is obtained, including a user search query, user-related information obtained in near real-time following the user search query, and a hybrid listing template or templates, among other information. The information may be stored in one or more databases 404,

At step 408, the method 400 queries whether a hybrid listing, or possible hybrid listing, will meet one or requirements for inclusion within an algorithmic search results section, including a minimum relevancy requirement. If not, then a hybrid listing is not provided. If so, then the method proceeds to step 412.

At step 412, a hybrid listing is generated utilizing information including template and near real-time user-related information.

At step 414, the hybrid listing is served within an algorithmic search results section of a page such as a Web page.

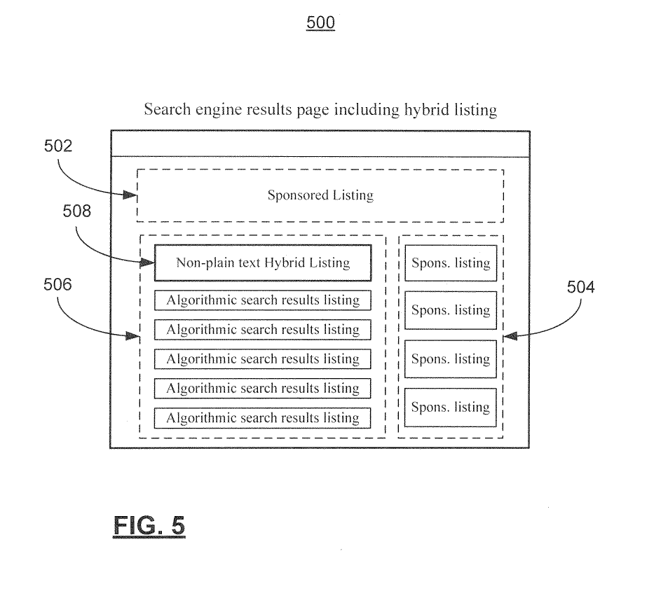

FIG. 5 is a block diagram illustrating one embodiment of the invention. FIG. 5 depicts a simplified example or a search engine results page 500 including hybrid listing. The page includes sponsored results sections 502, 504 as well as an algorithmic results section 506. The algorithmic results section 506 includes a hybrid listing, such as a non-plain text hybrid listing 508. Although one algorithmic results section 506 is depicted, more than one could be included. Furthermore, although one hybrid listing is depicted, more than one hybrid listing may be included.

In some embodiments, hybrid listings may be advertisements associated with advertiser payment, or possible, conditional, or downstream payment or a payment obligation. However, the hybrid listings may also be required to meet one or more requirements that are typically associated with algorithmic listings, or may be required to meet one or more requirements that are in between, a compromise, or a mix, for example, of those typically associated with algorithmic listings and those typically associated with sponsored listings For example, in some embodiments, hybrid listings may be required to meet relevance requirements, such as in connection with a user search and possibly other factors, which may be greater or different than any such requirement which may apply to sponsored listings. However, the relevancy requirement, or other requirements, may none the less be different or less stringent than those applicable to algorithmic listings. Additionally, in some embodiments, arrangements with advertisers may be different with hybrid listings than with sponsored listings. For example, an advertiser may have less control, influence or specificity with respect to hybrid listings than with sponsored listings. Furthermore, advertiser payment in connection with hybrid listings may be different than that associated with sponsored listings.

In some embodiments, hybrid listings, while advertisements, are subject to requirements or other conditions which make them more appropriate, or less likely to annoy users, than, for example, a sponsored listing appearing in an algorithmic results section of a Web page. Hybrid listings may, for example, be used in response to certain searches or search types, in which the hybrid listing may answer a question or provide information sought by the search. Additionally, hybrid listings may, for example, include non-prose or non-plain text elements, enhancements, or user-friendly elements, such as graphical elements, graphs, tables, deep links, coloring, interactive elements, animation, rich media elements such as audio or video, etc. Furthermore, they may include or make use of real time or near real time acquired information, such as information associated with a user and acquired after obtaining the user's search query. They may still further include or be associated with elements such as highlighting, bold or large fonts, outlining, etc. Such non-plain text elements or other elements may cause the hybrid listings to stand out above algorithmic listings in the algorithmic results section. In some embodiments, various characteristics associated with hybrid listings make them likely to satisfy or engage, rather than annoy, confuse, irritate, or draw the questioning of users, while yet providing a monetization element in connection with algorithmic results sections.

In some embodiments, advertisers or other parties may provide, select, modify, or have input in connection with templates that may be used in constructing or modifying hybrid listings, such as the creative element of a hybrid listing. This can allow for non-static creatives which do not need to be pre-specified completely, but which can instead be constructed in near real-time following a user search query, to provide a more effective or engaging listing. For example, an advertiser may provide or select a template that may be later be used in providing structural or contextual elements of or associated with, later constructed or served hybrid listings. For example, a template may provide format, content, or stylistic components, such as by specifying or partially specifying a graph or table structure, rich media structural elements, etc. After a user search query is obtained, the template may be used in constructing a hybrid listing to be served. In some embodiments, for example, user-associated information or parameters may be acquired after obtaining a user search query, and that information or derived information may be used to fill in, auto-populate or pre-populate elements of a hybrid listing. Alternatively, such information may be used or partially used in connection with a Web page indicated by a link contained in a hybrid listing. Such auto-population or fill in could be applicable, for example, to insurance quotes, rates tables, applications to be filled in with user information, etc. Furthermore, a creative of a hybrid listing may be modified in various ways based on real time or near real time acquired information or parameters, which can help in providing an engaging, effective, and attention-grabbing listing. Of course, hybrid listings may be targeted in various other ways as well, including geotargeting, behavioral targeting, etc.

In some embodiments, monetization and revenue sharing arrangements, such as between advertisers, advertisement selection and serving facilitator entities, advertisement marketplace providers, publishers, and potentially other parties, may be different for hybrid listings than for either algorithmic listings or sponsored listings.

In some embodiments, hybrid listings provide an answer to a user question posed by or implied by a search query more efficiently than with algorithmic listings, which may include surfacing non-plain text or non-prose information to answer the question. For example, a hybrid listing returned after a search query for “mortgage rates” may include a mortgage rate table, etc. Hybrid listings may also provide ability for advertisers to answer such questions, or provide content, within algorithmic results sections. For example, hybrid advertisements, or templates, may provide advertisers h the ability to identify or specify what types of information would satisfy user intent for various queries, so that the hybrid listing resonates with what use has in mind. Furthermore, the hybrid listing may include a link to a Web page that answers or further answers a user question, such as, as a possible example, a mortgage refinance information Web page if a user enters “refinance” as a query.

In some embodiments, the system identifies queries where structured, non-prose data can potentially answer a user's query, and a hybrid listing may be used to surface such information in response to those queries.

Furthermore, in some embodiments, placement or rank on a page or within an algorithmic results section may be determined strategically, such as by placing the hybrid listing in a location most likely to be noticed, or noticed by a user seeking an answer to a question, etc. Placement could also be based in part on the structure of the hybrid listing.

In some embodiments, the system can accept information or structured information from advertisers or data providers, such as periodically or a particular frequency or degree of recency, and use such information in later constructing hybrid listings. Furthermore, in some embodiments, such information, or elements of hybrid listings using or including such information, may be modified based on acquired information such as user behavior or other targeting information, for example. Still further, a feedback situation may exist between the system and an advertiser. For example, the system may aggregate user behavior information and make it available to the advertiser, such as to help inform the advertiser as to what type of content to best feed into the provided information, or template, such as to lead to optimal hybrid listing performance, return on investment, etc.

While invention is described with reference to the above drawings, the drawings are intended to be illustrative, and the invention contemplates other embodiments within the spirit of the invention.

1. A method comprising:
using one or more computers, in response to a user search query, providing a search results page comprising:
one or more sponsored results sections adapted to be distinguishable to the user as containing sponsored search listings, wherein sponsored search listings are advertisements; and
an algorithmic results section adapted to be distinguishable to the user as containing non-advertisement listings; and
using one or more computers, providing, within the algorithmic results section, a hybrid listing, wherein the hybrid listing is an advertisement that is determined to meet one or more requirements for inclusion in the algorithmic results section, and wherein the one or more requirements include a minimum relevancy requirement for inclusion in the algorithmic search results section.

2. The method of claim 1, wherein a hybrid listing is an advertisement that is determined to meet one or more requirements for inclusion in the algorithmic results section, and wherein the one or more requirements include a minimum relevancy requirement for inclusion in the algorithmic search results section, and wherein relevancy is at least in part in relation to the user search query.

3. The method of claim 1, comprising providing the search results page comprising an algorithmic results section adapted to be distinguishable to the user as containing only non-advertisement listings.

4. The method of claim 1, wherein providing a listing that is an advertisement comprises providing a listing associated with payment from an advertiser.

5. The method of claim 1, wherein display of a listing that is an advertisement, user selection of a listing that is an advertisement, a user action attributed to a listing that is an advertisement, user engagement attributed to a listing that is an advertisement, or a user conversion attributed to a listing that is an advertisement results in or adds to a payment obligation by an advertiser.

6. The method of claim 1, herein providing the hybrid listing comprises providing a listing that includes at least one non-plain text element.

7. The method of claim 1, wherein providing the hybrid listing comprises providing a listing that includes at least one non-plain text element comprising at least one non-text graphical element.

8. The method of claim 1, wherein providing the hybrid listing comprises providing a listing that includes at least one non-plain text element comprising at least one rich media element.

9. Thu method of claim 1, wherein, for the hybrid listing, an advertiser submits or selects a template, and wherein, following entry of the user search query, the template is utilized in constructing a creative of the hybrid listing.

10. The method of claim 1, wherein, for hybrid listings, an advertiser submits or selects a template, and wherein, following entry of the user search query, the template is utilized in constructing a creative of the hybrid listing, and wherein the template comprises one or more non-plain text structural elements associated with the creative.

11. The method of claim 1, wherein, for hybrid listings, an advertiser submits or selects a template, wherein the template comprises one or more non-plain text structural elements associated with creatives of hybrid listings, and wherein, following entry of the user search query, the template is utilized in constructing a creative of the hybrid listing, and wherein, following entry of the user search query, the template is filled in utilizing information associated with the user and acquired following entry of the user search query.

12. The method of claim 1, wherein the hybrid listing is paid for by an advertiser.

13. The method of claim 1, wherein display of the hybrid listing, user selection of the hybrid listing, a user action attributed to the hybrid listing, user engagement attributed to the hybrid listing, or a conversion attributed to the hybrid listing results in or adds to a payment obligation by an advertiser.

14. The method of claim 1, comprising providing the hybrid listing, wherein the hybrid listing is adapted to be more noticeable to the user than other listings in the algorithmic results section.

15. The method of claim 1, comprising providing the hybrid listing, wherein the hybrid listing is adapted to at least partially answer a question posed or suggested by the user search query.

16. A system comprising:
one or more server computers coupled to a network; and
one or more databases coupled to the one or more server computers;
wherein the one or more server computers are for:
in response to a user search query, providing a search results page comprising:
one or more sponsored results sections adapted to be distinguishable to the user as containing sponsored search listings, wherein sponsored search listings are advertisements; and
an algorithmic results section adapted to be distinguishable to the user as containing non-advertisement listings; and
providing, within the algorithmic results section, a hybrid listing, wherein the hybrid listing is an advertisement that is determined to meet one or more requirements for inclusion in the algorithmic results section, and wherein the one or more requirements include a minimum relevancy requirement for inclusion in the algorithmic search results section.

17. The system of claim 16, wherein at least one of the one or more server computers are coupled to the Internet.

18. The system of claim 16, wherein, for the hybrid listing, an advertiser submits or selects a template, and wherein, following entry of the user search query, the template is utilized in constructing a creative of the hybrid listing.

19. The system of claim 16, wherein, for hybrid listings, an advertiser submits or selects a template, and wherein, following entry of the user search query, the template is utilized in constructing a creative of the hybrid listing, and wherein the template comprises one or more non-plain text structural elements associated with the creative.

20. A computer readable medium or media containing instructions for executing a method comprising:
using one or more computers, in response to a user search query, providing a search results page comprising:
one or more sponsored results sections adapted to be distinguishable to the user as containing sponsored search listings, wherein sponsored search listings are advertisements; and
an algorithmic results section adapted to be distinguishable to the user as containing only non-advertisement listings; and
using one or more computers, providing, within the algorithmic results section, a hybrid listing, wherein the hybrid listing is an advertisement that is determined to meet one or more requirements for inclusion in the algorithmic results section, and wherein one or more requirements include a minimum relevancy requirement for inclusion in the algorithmic search results section;
wherein, for hybrid listings, an advertiser submits or selects a template, and wherein, following entry of the user search query, the template is utilized in constructing a creative of the hybrid listing, and wherein the template comprises one or more non-plain text structural elements associated with the creative.
